(19) United States
(12) Patent Application Publication
(10) Pub. No.: US 2015/0179139 A1
(43) Pub. Date: Jun. 25, 2015

(54) DISPLAY APPARATUS

(71) Applicant: Sharp Kabushiki Kaisha, Osaka (JP)

(72) Inventors: Hisashi Watanabe, Osaka (JP); Eiji Satoh, Osaka (JP)

(73) Assignee: Sharp Kabushiki Kaisha, Osaka (JP)

(21) Appl. No.: 14/420,054

(22) PCT Filed: Aug. 1, 2013
(86) PCT No.: PCT/JP2013/070853

§ 371 Date: Feb. 6, 2015

(30) Foreign Application Priority Data
Aug. 10, 2012 (JP) 2012-178524

(51) Int. Cl. G09G 5/02; G09G 3/34; G09G 3/32; G09G 3/36; G06T 11/00; G09G 3/20

(52) U.S. Cl. CPC G09G 5/026; G06T 11/001; G09G 3/2003; G09G 3/3208; G09G 3/36; G09G 3/3413; G09G 2310/0232; G09G 2360/144

(57) ABSTRACT

Provided is a display apparatus which is capable of indicating information, such as a name of a manufacturer, while achieving a state wherein a frame region is narrow or the frame region is not seen, at the time of providing images to a user. A display apparatus has: a first display panel that has a first display region; and a second display panel that is disposed on the observer side of the first display region. When the first display panel is in a display state, the second display panel becomes transparent, and when the first display panel is in a non-display state, the second display panel displays previously determined information.

### TECHNICAL FIELD

The present invention relates to a display device, and more particularly, to a direct view display device.

### BACKGROUND ART

In recent years, the frame region that is found in the periphery of the display region of a display panel has become narrower. In a TFT liquid crystal display panel, for example, the frame region includes: a driver circuit that is connected to gate bus lines, source bus lines, or the like for supplying a prescribed voltage to a plurality of pixels arranged in the display region; wiring and terminals for connecting the driver circuit to an external circuit; sealing parts for sealing and retaining a liquid crystal layer between two glass substrates; and the like.

While it is not possible to eliminate the frame region, Patent Document 1 submitted by this applicant discloses a technology that visually conceals at least a part of the frame region (for example, the frame region that is found along two sides aligned horizontally) by providing a light-transmissive cover that has a lens portion.

### RELATED ART DOCUMENTS

### Patent Documents

Patent Document 1: WO 2010/070871

Patent Document 2: Japanese Patent Application Laid-Open Publication No. 2009-98469

### SUMMARY OF THE INVENTION

### Problems to be Solved by the Invention

However, when a frame region becomes narrow or the frame region is not seen, as described above, a problem arises: it is no longer possible to secure a region for indicating such information as a name of a manufacturer, a name of a brand, a logo, a trademark, a name of a product, a model number, and/or performance that have been shown in the frame region (typically, a bezel) so far. This problem is not limited to liquid crystal display panels, but is a problem common to display devices using other known display panels.

In this connection, Patent Document 2 discloses a liquid crystal display device that is capable of displaying prescribed letters, logo, or the like when the power is turned off. In this liquid crystal display device, display during power off is realized by a plurality of sub-pixel groups equipped with a light-reflective region. Problems arise when this configuration is employed, including a reduced effective aperture ratio of the pixels used to display actual images.

The present invention has been made to solve the problem described above. The present invention aims to provide a display device capable of displaying information such as a name of a manufacturer while achieving a state in which the frame region is narrow or the frame region is not seen at the time of providing images to a user.

### Means for Solving the Problems

A display device according one embodiment of the present invention includes: a first display panel that has a first display region; and a second display panel that is disposed on an observer side of the first display region; wherein the second display panel becomes transparent when the first display panel is in a display state, and displays prescribed information when the first display panel is in a non-display state.

In one aspect, the display device further includes a light-transmissive cover disposed on the observer side of the first display panel.

In one aspect, the light-transmissive cover includes a lens portion having curved edges, and a flat-plate portion, and the lens portion causes a portion of light emitted from the first display region to be refracted towards a direction normal to the first display panel.

In one aspect, the second display panel is interposed between the first display panel and the light-transmissive cover.

In one aspect, the light-transmissive cover has a recessed section, and at least a part of the second display panel is disposed in the recessed section.

In one aspect, the second display panel is capable of realizing display using ambient light. The second display panel is, for example, a polymer dispersed liquid crystal-mode liquid crystal display panel, a liquid crystal display that has a cholesteric liquid crystal layer, an electrochromic display panel, or a display panel that has a suspension layer containing shape-anisotropic particles. A display device in one aspect further includes a light source that illuminates the second display panel. A display device in one aspect further includes a sensor that detects intensity of ambient light.

In one aspect, the second display panel is a self-luminous type display panel. The self-luminous type display panel is, for example, an organic electroluminescent display panel.

### Effects of the Invention

Provided, according to one embodiment of the present invention, is a display device, which is capable of indicating information such as a name of a manufacturer while achieving a state where the frame region is narrow or the frame region is not seen at the time of providing images to a user.

### BRIEF DESCRIPTION OF THE DRAWINGS

FIGS. 1(a) to 1(c) are diagrams that schematically show a display device 100A according to an embodiment of the present invention. FIG. 1(a) is a plan view from the observer side, FIG. 1(b) is a horizontal cross-sectional view, and FIG. 1(c) is a vertical cross-sectional view.

FIG. 2 shows diagrams that explain operation states of the display device 100A. FIG. 2(a) shows the operation state of the display device 100A when a first display panel 100 is in a display state. FIG. 2(b) shows the operation state of the display device 100A when the first display panel 100 is in a non-display state.

FIG. 3 shows diagrams that schematically illustrate a display device 100B according to another embodiment of the present invention. FIG. 3(a) is a plan view from the observer side, FIG. 3(b) is a horizontal cross-sectional view, and FIG. 3(c) is a vertical cross-sectional view.

FIGS. 4(a) and 4(b) respectively show schematic cross-sectional views of other light-transmissive covers 200a and 200b used for the display device 100B.

FIGS. 5(a) to 5(c) are diagrams that show a PDLC-mode liquid crystal display panel 150a used for a display device according to one embodiment of the present invention. FIG. 5(a) shows a state in which no voltage is applied to a liquid crystal layer 13a, and FIG. 5(b) shows a state in which a voltage is applied to the liquid crystal layer 13a. FIG. 5(c) is a schematic perspective view of the display panel 150a.

FIGS. 6(a) and 6(b) are diagrams that show another PDLC-mode liquid crystal display panel 150b used for a display device according to one embodiment of the present invention. FIG. 6(a) shows a state in which no voltage is applied to a liquid crystal layer 13a, and FIG. 6(b) shows a state in which a voltage is applied to the liquid crystal layer 13a.

FIGS. 7(a) and 7(b) schematically show a liquid crystal display panel 150c having a cholesteric liquid crystal layer 13c that is used for a display device according to one embodiment of the present invention. FIG. 7(a) shows a state in which no voltage is applied to the liquid crystal layer 13c, and FIG. 7(b) shows a state in which a voltage is applied to the liquid crystal layer 13c.

FIG. 8 is a schematic diagram that shows an electrochromic display panel 150d used for a display device according to one embodiment of the present invention.

FIG. 9 is a schematic diagram that shows a flake-type display panel 150e used for a display device according to one embodiment of the present invention.

FIG. 10 is a schematic diagram that shows another display panel 150f used for a display device according to one embodiment of the present invention.

FIGS. 11(a) and 11(b) are diagrams that respectively show other display devices 100C and 100D according to one embodiment of the present invention.

FIG. 12(a) is a schematic top view of a display device 100A. FIG. 12(b) is a schematic cross-sectional view of the display device 100A along a 1B-1B′ line on FIG. 12(a).

FIG. 13(a) is a schematic perspective view of a light-transmissive cover 200. FIG. 13(b) is another light-transmissive cover 200′.

### DETAILED DESCRIPTION OF EMBODIMENTS

The embodiments of the present invention will be explained in detail below with reference to diagrams. However, the present invention is not limited to the embodiments illustrated herein.

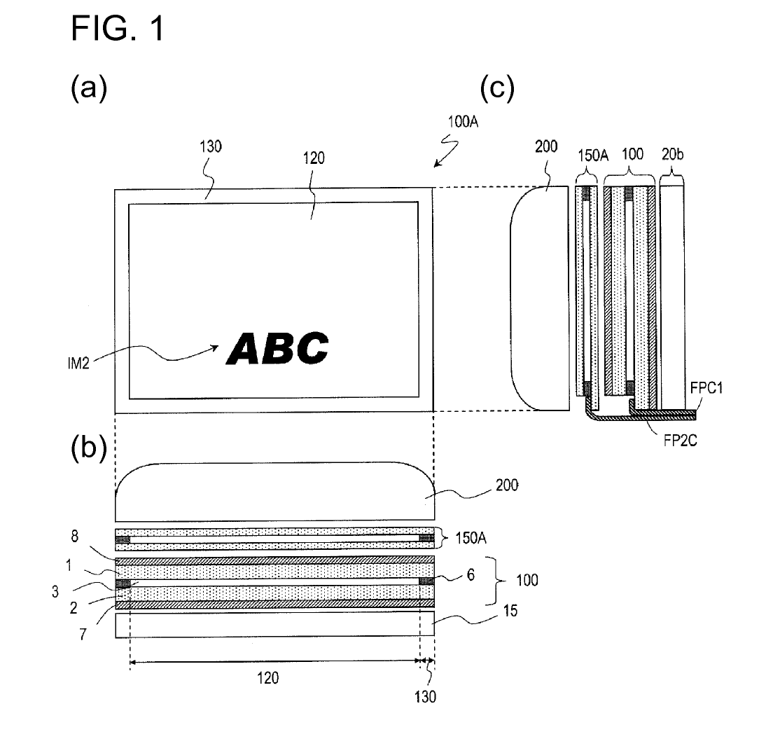

FIGS. 1(a) to 1(c) schematically show a display device 100A according to an embodiment of the present invention. FIG. 1(a) is a plan view of the display device 100A, FIG. 1(b) is a horizontal cross-sectional view of the display device 100A, and FIG. 1(c) is a vertical cross-sectional view of the display device 100A.

The display device 100A has: a first display panel 100 that has a first display region 120; and a second display panel 150A that is disposed on the observer side of the first display region 120. When the first display panel 100 is in a display state, the second display panel 150A becomes transparent, and when the first display panel 100 is in a non-display state, the second display panel 150A displays previously determined information. Previously determined information includes, for example, a name of a manufacturer, a name of a brand, a logo, a trademark, a name of a product, a model number, and/or performance.

The display device 100A also has a light-transmissive cover 200 that is disposed on the observer side of the first display panel 100. The light-transmissive cover 200 includes: a lens portion that has edges with a curved surface; and a flat-plate portion. The lens portion refracts a part of light emitted from the first display region 120 toward the direction normal to the first display panel 100. Here, the second display panel 150A is interposed between the first display panel 100 and the light-transmissive cover 200.

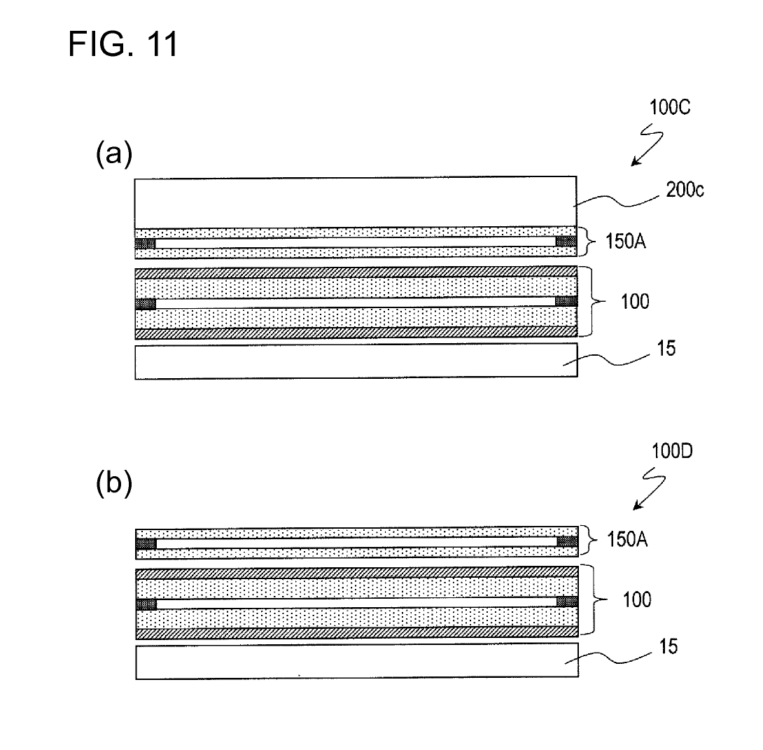

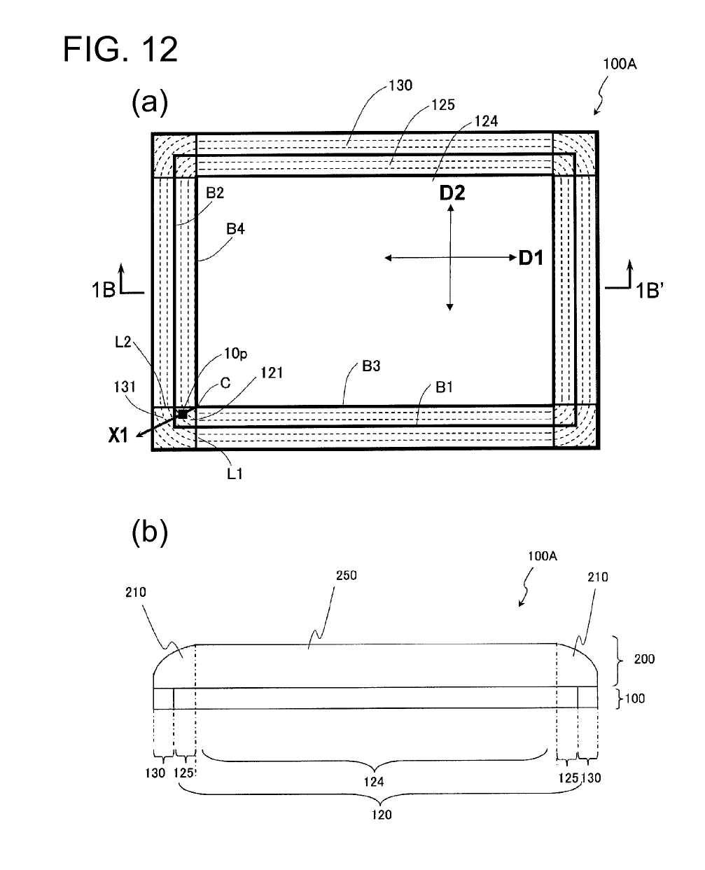

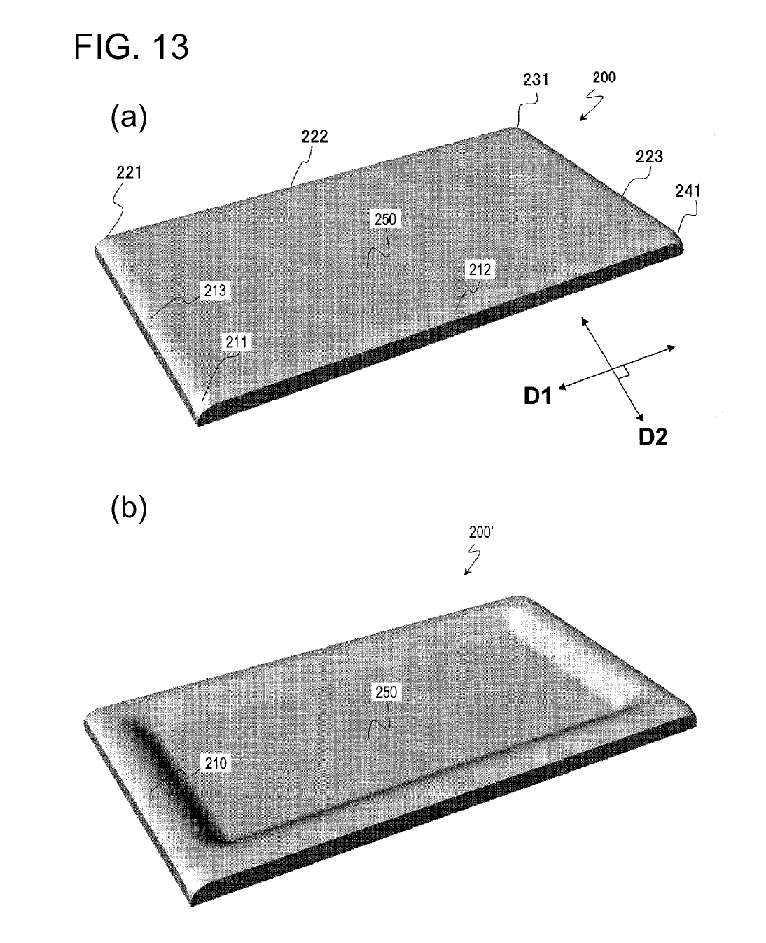

The first display panel 100 has a frame region 130 on the outside of the first display region 120. However, the light-transmissive cover 200 makes the frame region 130 visually concealed, or visually inconspicuous, to the observer. Examples described in Patent Document 1 are suitable as a light-transmissive cover 200 that is equipped with such a function. The entire disclosed contents of Patent Document 1 are incorporated in the specification of this application by reference. Specific examples of the light-transmissive cover 200 will also be explained below with reference to FIGS. 12 and 13. Additionally, as will be described below with reference to FIG. 11, a light-transmissive cover without a lens portion may be used, or a light-transmissive cover may be omitted altogether.

For the first display panel 100, various known display panels, such as a liquid display panel, an organic EL display panel, a PDP, an FED, or an electrowetting display panel, may be used. Here, a liquid crystal panel 100 is used as an example.

The liquid crystal panel 100 can be any known liquid crystal display panel. The liquid crystal display panel 100 has an upper substrate 1, a lower substrate 2, and a liquid crystal layer 3 provided between the upper substrate 1 and the lower substrate 2. The lower substrate 2 has, for example, TFTs and pixel electrodes, and the upper substrate 1 has, for example, a color filter layer and a common electrode. Further, the liquid crystal display panel 100 has a polarizing plate 8 disposed above the upper substrate 1 and a polarizing plate 7 disposed below the lower substrate 2. Naturally, the liquid crystal display panel 100 may further include various optical sheets such as retardation plates, if needed. Formed in the frame region 130 of the liquid crystal display panel 100 are sealing parts 6, driving circuits, and the like. Below the liquid display panel 100, a backlight device 15 is provided. The backlight device 15 is, for example, a direct-lit backlight device equipped with a plurality of fluorescent lamps placed parallel to one another.

Various known display panels may be used as the second display panel 150A as well. A second display panel 150A only has to be capable of becoming transparent when the first display panel 100 is in a display state and displaying previously determined information when the first display panel 100 is in a non-display state. Since information is displayed as images, information may be treated as equivalent to images in some cases.

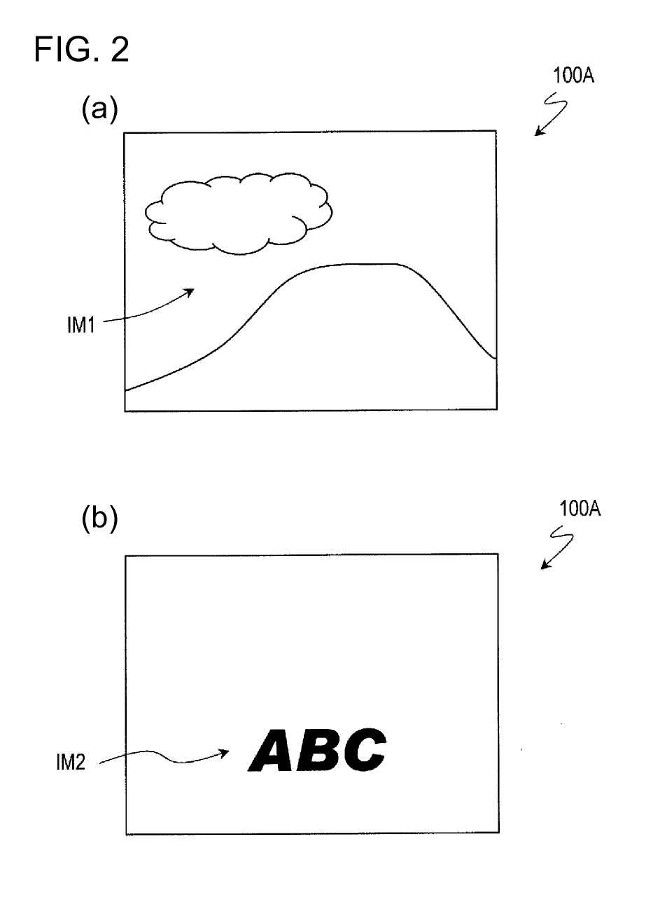

An operation state of the display device 100A will be explained with reference to FIGS. 2(a) and 2(b). FIG. 2(a) shows an operation state of the display device 100A when the first display panel 100 is in a display state, and FIG. 2(b) shows an operation state of the display device 100A when the first display panel 100 is in a non-display state.

As shown in FIG. 2(a), when the first display panel 100 is in a display state, the second display panel 150A becomes transparent, and the observer sees an image IM1 displayed by the first display panel 100. At this time, the frame region 130 of the first display panel 100 is visually concealed by the light-transmissive cover 200 that has a lens portion.

In contrast, when the first display panel 100 is in a non-display state, the observer sees an image IM2 displayed by the second display panel 150A, as shown in FIG. 2(b).

The purpose of the display device 100A is to display images to the observer using the first display panel 100. Therefore, when the first display panel 100 is in a non-display state, the display device 100A is assumed to be in a non-operational state; in other words, the power of the display device 100A is assumed to be turned off. It is highly preferable, therefore, that the second display panel 150A, which displays the image IM2 at this time, not consume power. Since the display device 100A can be used for a broad range of purposes, the second display panel 150A can be configured according to the purpose for which it is used. Specific examples of the second display panel 150A will be described later.

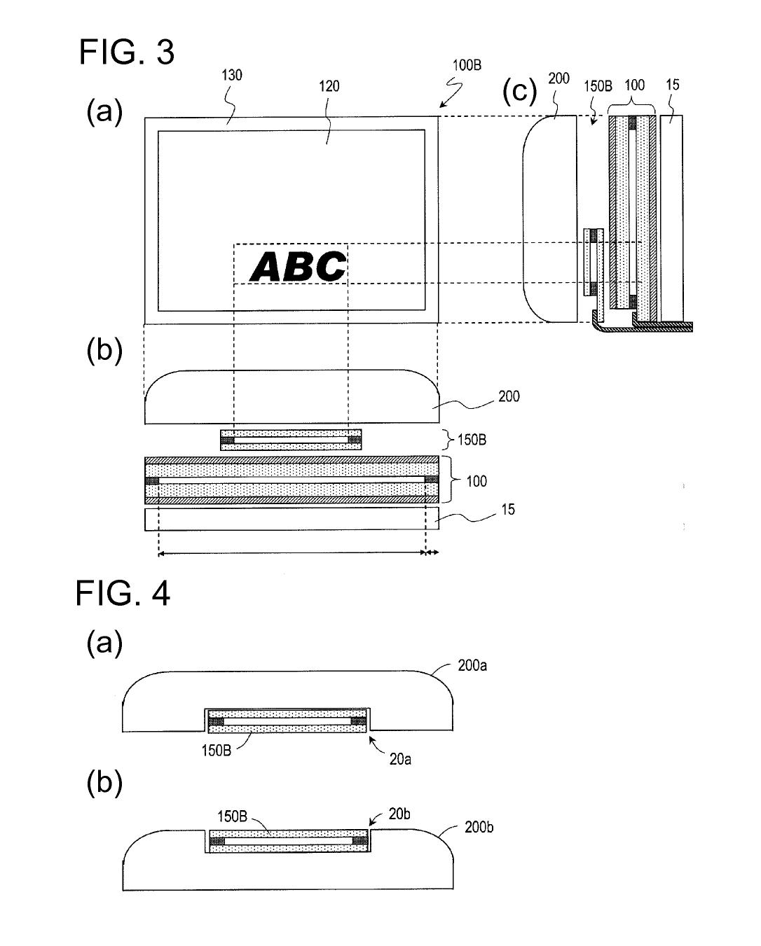

Next, a display device 100B according to another embodiment of the present invention will be explained with reference to FIGS. 3(a) to 3(c).

The second display panel 150A of the display device 100A shown in FIG. 1 has an external size identical to the first display panel 100. However, from the perspective of the observer, the image IM2 provided by the second display panel 150A is displayed on only a part of the display region 120 of the first display panel 100. Therefore, a smaller second display panel 150B that has an area necessary for displaying the image IM2 may be used, as is done in the display device 100B shown in FIGS. 3(a) to 3(c).

However, when the first display panel 100 is in a display state, the observer sees the image IM1 displayed by the first display panel 100 through the entire second display panel 150B. It is preferable, therefore, that the entire second display panel 150B be transparent. With respect to the second display panel 150A shown in FIG. 1, even if an opaque sealing part is provided in the periphery of the display region, for example, images displayed by the first display panel 100 will not be blocked from view, provided that the sealing part, along with the frame region 130 of the first display panel 100, is in a region that is visually concealed from the observer by the light-transmissive cover 200. In contrast, if the second display panel 150B shown in FIG. 3 has an opaque sealing part, images displayed by the first display panel 100 will be blocked from view. Additionally, uneven luminance within the first display region 120 of the first display panel 100 will visually bother the observer. Therefore, it is preferable that the transmittance of the second display panel 150B be at least 50%.

Next, modified examples of the light-transmissive cover 200 will be explained with reference to FIGS. 4(a) and 4(b).

The second display panel 150B shown in FIG. 3 is smaller than the first display panel 100 in outer diameter (the planar size when seen by the observer). Therefore, a recess section 20a or 20b may be provided to dispose at least a part of the second display panel 150B in the recess section 20a or 20b, as exemplified by light-transmissive covers 200a and 200b shown in FIGS. 4(a) and 4(b). However, a larger distance between the second display panel 150B and the first display panel 100 may cause images to become blurry. Therefore, it is preferable that the configuration of FIG. 4(a), in which the distance between the second display panel 150B and the first display panel 100 is small, be employed.

It is preferable that second display panels 150A and 150B be thin, and that resin substrates, for example, be used as substrates that constitute these panels. Specifically, a polyethylene terephthalate (PET) film of approximately 50 μm may be used. Since images displayed by the second display panels 150A and 150B are simple and predetermined, the images may be displayed using segmented electrodes. Therefore, because there is no need to form switching elements such as TFTs, requirements on heat resistance and dimensional stability during the manufacturing process are low and there are few adverse effects resulting from using a resin substrate.

The first display panel 100 and the second display panels 150A and 150B were illustrated using typical rectangular display panels. Needless to say, however, there are no limitations on the external shapes of these display panels. In addition to polygons such as rectangles (including rectangles and squares), polygons with rounded corners, ovals, circles, or combinations thereof are also acceptable.

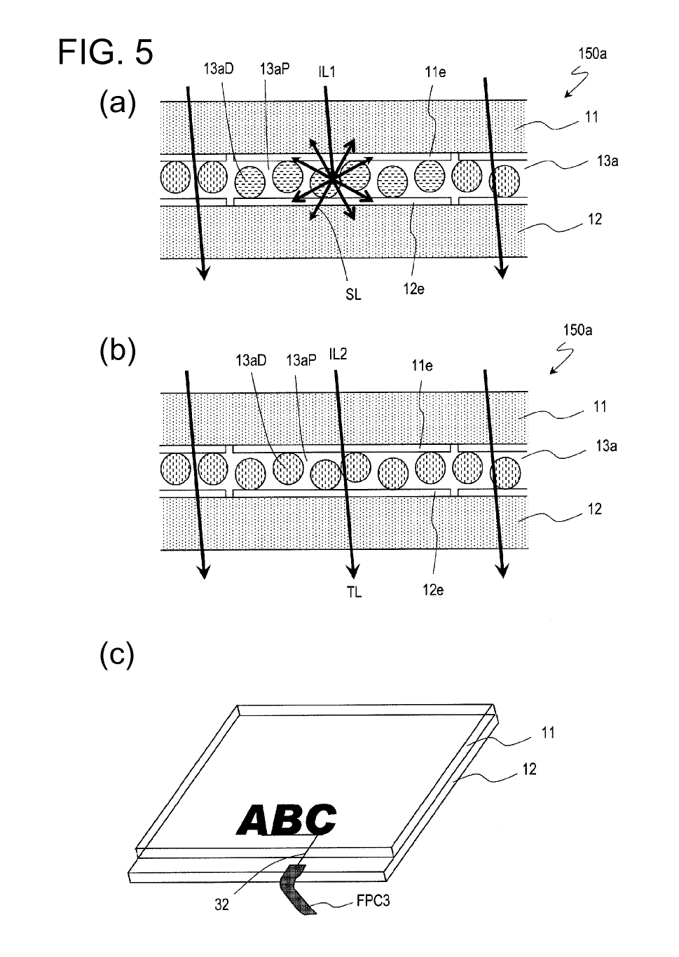

Next, specific examples of display panels that may be used as a second display panel 150A are explained with reference to FIGS. 5 to 10. Naturally, the following display panels may also be used as a second display panel 150B.

As stated above, the second display panel 150A displays previously determined information (images) when the first display panel 100 is in a non-display state. Therefore, it is highly preferable that the second display panel 150A, which displays images at this time, not consume power. Below, display panels 150a to 150e are provided as examples of display panels that are capable of realizing display using ambient light.

The display panel 150a shown in FIGS. 5(a) to 5(c) is a Polymer Dispersed Liquid Crystal (PDLC) mode liquid crystal display panel. A liquid crystal layer 13a that is formed between two substrates 11 and 12 has a polymer phase 13aP and liquid crystal droplets 13aD. The liquid crystal droplets 13aD are dispersed in the polymer phase 13aP. A PDLC-mode liquid crystal display panel realizes display by switching to and from a transparent state, which is achieved when there is a match between the refractive index of the polymer phase 13aP and the refractive index of the liquid crystal droplets 13aD, and a scattering state, which is achieved when there is a mismatch between the refractive index of the polymer phase 13aP and the refractive index of the liquid crystal droplets 13aD, by varying the voltage applied to the liquid crystal layer 13a. The transparent state displays black (low luminance), and the scattering state displays white (high luminance). Various types of PDLC-mode liquid crystal display panels are known, with different combinations of: refractive index anisotropy and dielectric anisotropy of the liquid crystal material; orientation state of the liquid crystal molecules; and refractive index of the polymer phase (whether or not there is refractive index anisotropy). Additionally, PDLC in some cases is referred to as PNLC (Polymer Network Liquid Crystal). One characteristic of a PDLC-mode liquid crystal display panel is that a polarizing plate is not required.

With respect to the display panel 150a, when no voltage is applied between electrodes 11e and electrodes 12e that face each other across the liquid crystal layer 13a, light scattering is caused by a mismatch of refractive indices between the polymer phase 13aP and the liquid crystal droplets 13aD, as shown in FIG. 5(a). Consequently, ambient light IL1 that is incident on the display panel 150a is scattered by the liquid crystal layer 13a, generating scattered light SL. The scattered light SL, exiting to the side of the observer, is perceived as milky white.

In contrast, when a voltage is applied between the electrodes 11e and the electrodes 12e, the liquid crystal molecules in the liquid crystal droplets 13aD align parallel to the electric field, as shown in FIG. 5(b). Materials for the liquid crystals and the polymer are selected such that the ordinary refractive index (n₀) of the liquid crystal molecules matches the refractive index (nₚ, isotropic) of the polymer phase 13aP. In other words, ambient light IL2 that is incident on the display panel 150a is transmitted through the liquid crystal layer 13a, and becomes transmitted light TL. That is, the display panel 150a becomes transparent at this time.

The electrodes 11e and 12e are, for example, segmented electrodes, and are patterned such that previously determined images can be displayed on the display panel 150a. As shown in FIG. 5(c), the electrodes 11e and 12e are, for example, connected to a flexible substrate FPC3 via a transparent lead-out wire 32, and a prescribed voltage is supplied from the flexible substrate FPC3. Such an electrical wiring structure may be employed not only for the display panel 150a, but also for all of display panels 150b to 150f, which will be explained below.

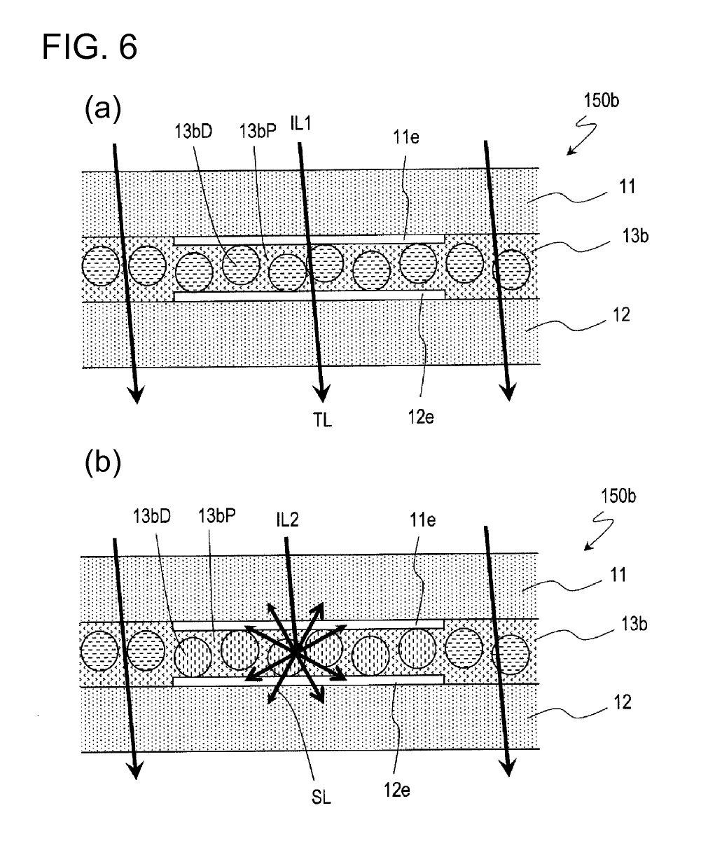

A display panel 150b, shown in FIGS. 6(a) and 6(b), is a PDLC-mode liquid crystal display panel that is different in type from the display panel 150a.

A liquid crystal layer 13b of the display panel 150b includes a polymer phase 13bP, which has a refractive index anisotropy that is comparable to the refractive index anisotropy of the liquid crystal molecules of liquid crystal droplets 13bD (in an orientation when no voltage is applied). Therefore, when no voltage is applied to the liquid crystal layer 13b, ambient light IL1 that is incident on the display panel 150b is transmitted through the liquid crystal layer 13b, and becomes transmitted light TL, as shown in FIG. 6(a). In other words, the display panel 150b becomes transparent at this time.

In contrast, when a voltage is applied between an electrode 11e and an electrode 12e, the liquid crystal molecules within the liquid crystal droplets 13bD orient parallel to the electric field, as shown in FIG. 6(b). At this point, because the ordinary refractive index (n₀) of the liquid crystal molecules does not match the refractive index (nₚ, anisotropic) of the polymer phase 13bP, light scattering occurs. Therefore, ambient light IL2 that is incident on the display panel 150b is scattered by the liquid crystal layer 13b, generating scattered light SL. The scattered light SL, exiting to the observer side, is perceived as milky white.

As described above, it is necessary to apply a voltage to the liquid crystal layer 13b so that the display panel 150b can display previously determined information (images). For this reason, from a viewpoint of power consumption during a non-display state of the first display panel 100, it can be said that the display panel 150a is preferable.

A Dynamic Scattering Mode (DSM) liquid display panel may also be used as a liquid crystal display panel capable of switching between a scattering state and a transmissive state.

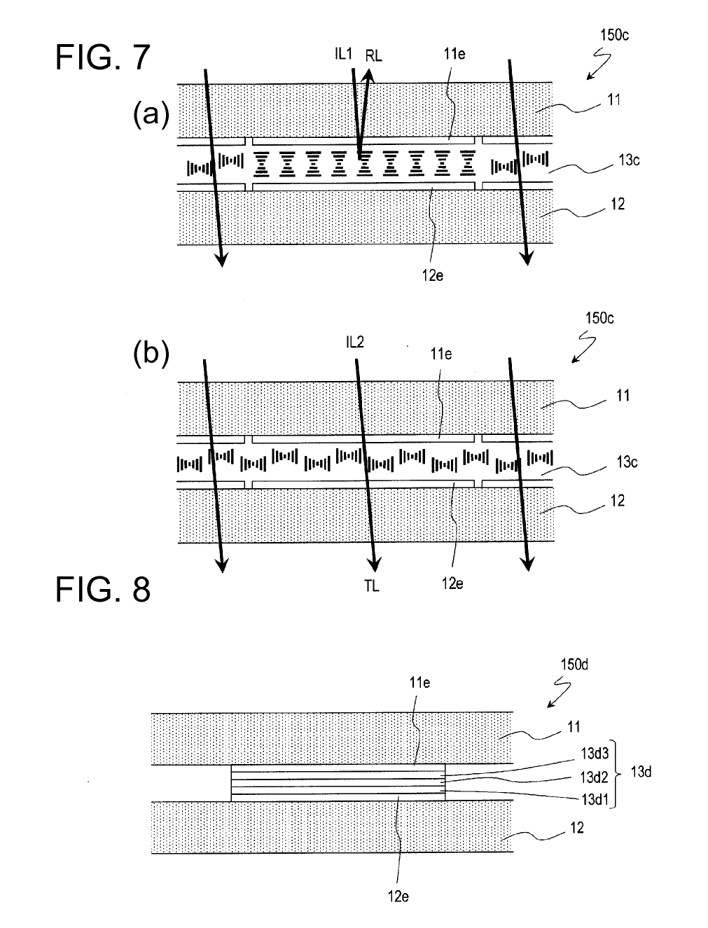

A display panel 150c, shown next in FIGS. 7(a) and 7(b), is a liquid crystal display panel that has a cholesteric liquid crystal layer 13c. The liquid crystal layer 13c that is formed between two substrates 11 and 12 includes a cholesteric liquid crystal material. A cholesteric liquid crystal material is obtained, for example, by mixing a chiral material with a nematic liquid crystal material such that the proportion of the chiral material is several tens of percent by mass. The orientational structure of the cholesteric liquid crystal material is such that the liquid crystal molecules are twisted in a helical pattern (cholesteric phase). Additionally, the cholesteric liquid crystal material has a bistable property (memory property), and is capable of achieving a planar state, in which light in specific wavelengths is reflected, a focalconic state, in which light is allowed to pass through, or an intermediate state thereof, depending on the intensity of the voltage applied to the liquid crystal layer 13c. Once one of these states is achieved, it is possible to maintain the state even if no voltage is applied to the liquid crystal layer 13c thereafter. Electronic paper that is commercially available may be used as a liquid crystal display panel that has the cholesteric liquid crystal layer 13c.

With respect to the display panel 150c, when no voltage is applied between electrodes 11e and electrodes 12e that face each other across a liquid crystal layer 13c, the liquid crystal layer 13c assumes a planar state. An ambient light IL1 that is incident on the display panel 150a is selectively reflected by the liquid crystal layer 13c, and generates a reflected light RL. Since the reflected light RL exits to the observer side, the observer perceives a color determined by the wavelength of the reflected light RL.

In contrast, when a voltage is applied between the electrodes 11e and 12e, the liquid display layer 13c assumes a focalconic state, as shown in FIG. 7(b). At this time, an ambient light IL2 that is incident on the display panel 150c is transmitted through the liquid display layer 13c, and becomes a transmitted light TL. In other words, the display panel 150c is in a transparent state at this time.

Thus, with respect to the display panel 150c, it is necessary to set the liquid crystal layer 13c to a planar state so as to display previously determined information (images). However, since it is not necessary to apply a voltage thereafter, very little power is consumed when the first display panel 100 is in a non-display state. Additionally, when the first display panel 100 is in a display state, there is no need to apply a voltage after the liquid crystal layer 13c is set to a focalconic state by applying a voltage once. Therefore, very little power is consumed when the first display panel 100 is in a display state as well.

It is also possible to use an electrochromic display panel 150d, shown in FIG. 8. A broad range of known electrochromic display panels may be used (for example, see Japanese Patent Application Laid-Open Publication S63-276035).

The display panel 150d has, for example, an electrochromic medium layer 13d between an upper electrode 11e and a lower electrode 12e. The electrochromic medium layer 13d includes an oxidized electrochromic layer 13d1, a reduced electrochromic layer 13d3, and an electrolyte layer 13d2 provided between the oxidized electrochromic layer 13d1 and the reduced electrochromic layer 13d3. The reduced electrochromic layer 13d3 provided on the upper electrode 11e side of the electrolyte layer (ion conducting layer) 13d is formed by, for example, a tungsten oxide layer. The oxidized electrochromic layer 13d1 provided on the lower electrode 12e side of the electrolyte layer 13d2 is formed by a mixed layer of indium oxide and tin oxide. The upper electrode 11e and the lower electrode 12e are transparent electrodes such as ITO layers, for example.

When a DC voltage is applied, an electrochromic layer (reduced or oxidized) reacts by coloration or discoloration, and by an opposite reaction (discoloration or coloration) when a DC voltage of reversed polarity is applied. Additionally, once coloration or discoloration is achieved by applying a DC voltage, that state is maintained even if no voltage is applied thereafter. If the upper electrode 11e and the lower electrode 12e are transparent electrodes as described above, the colored state is a high-reflectance state, whereas the discolored state (transparent state) is a low-reflectance state. On the other hand, when the upper electrode 11e is a transparent electrode and the lower electrode 12e is a reflective electrode (an aluminum electrode, for example), the colored state is a low-reflectance state and the discolored state is a high-reflectance state.

Thus, the display panel 150d that includes an electrochromic layer has a memory property in a manner similar to the display panel 150c that includes a cholesteric liquid layer 13c, and therefore has the advantage of low power consumption. However, the transmittance is low in a discolored state, and a shadow of an image intended for display may be visually recognized in some cases.

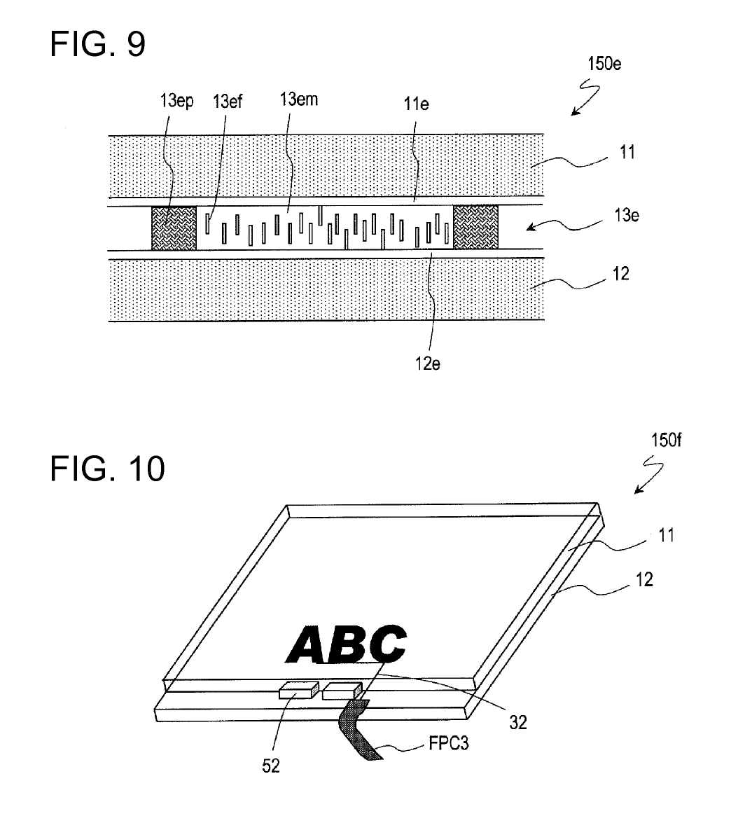

Further, it is also possible to use a flake-type display panel 150e shown in FIG. 9. Here, a “flake-type” display panel refers to a display panel that has, as a display medium layer, a suspension layer containing shape-anisotropic particles (flakes). Such a display panel is described in, for example, the Japanese Translation of PCT International Application Publication No. 2007-506152, the specification of U.S. Pat. No. 6,665,042, and the specification of U.S. Pat. No. 6,829,075. Additionally, the applicant of the this application described in Patent Application No. 2012-009445 a display panel that controls the alignment of flakes by switching the voltage applied to the suspension layer between high frequency and low frequency. The entire disclosed contents of the Japanese Translation of PCT International Application Publication No. 2007-506152, the specification of U.S. Pat. No. 6,665,042, the specification of U.S. Pat. No. 6,829,075, and Patent Application No. 2012-009445 are incorporated in this specification by reference.

The display panel 150e has a suspension layer 13e within a region partitioned by walls 13ep between two substrates 11 and 12. The suspension layer 13e has a liquid medium 13em and flakes 13ef, which are dispersed in the liquid medium 13em. The flakes 13ef are metal flakes that are capable of reflecting light, and are, for example, disk-shaped aluminum flakes with a diameter of 20 μm and a thickness of 0.3 μm. It is preferable that the liquid medium 13em be a material that is highly transparent against visible light, and that its viscosity be 5 mPa·s or less from the viewpoint of response characteristics and 0.5 mPa·s or more from the viewpoint of preventing the flakes 13ef from settling to the bottom. In addition, it is preferable that the specific gravity of the liquid medium 13em be close to the specific gravity of the flakes 12df. As a liquid medium 13em, brominated hydrocarbons (tetrabromoethane or the like), propylene carbonate, NMP (N-Methyl-2-pyrrolidone), fluorocarbons, or silicone oil may be used, for example. It is preferable that the walls 13ep also be highly transparent against visible light, and the walls 13ep may be formed by using a transparent photoresist material, for example.

When a high-frequency (30 Hz to 1 KHz; 60 Hz, for example) voltage is applied between an electrode 11e an electrode 12e that face each other across the suspension layer 13e therebetween, the disk-shaped aluminum flakes 13ef become aligned such that that the diameters of the disks are parallel to the line of electric force, and the incident ambient light is transmitted through the suspension layer 13e. In other words, the suspension layer 13e becomes transparent. At this time, the transmittance is approximately 70% or more, and there is no adverse influence on the display on the first display panel.

In contrast, when a low-frequency (0.0 Hz to 0.5 Hz; 0.1 Hz, for example) voltage (or a DC voltage) is applied to the suspension layer 13e, the aluminum flakes 13ef become aligned such that the diameters of the disks are perpendicular to the line of electric force, and the incident ambient light is reflected by the suspension layer 13e. At this time, the reflectance is approximately 50%, for example, generating easily viewable display.

However, since it is necessary to apply a prescribed voltage to the suspension layer 13e to set the suspension layer 13e to a transparent state or a reflective state (display state), power is consumed as a result.

The display panels 150a to 150e illustrated above realize display using ambient light. As such, no light source is required, and the amount of power consumption is small in this regard. Additionally, the display panels 150a to 150e are able to provide easily viewable display in an environment with strong ambient lighting. In terms of viewability of display, the electrochromic display panel 150d is superior, followed by the flake-type display 150e and the cholesteric liquid display panel 150c in that order, with the PDLC-mode liquid display devices 150a and 150b faring slightly worse. When the efficiencies of light utilization of the display panels during a display state are expressed in terms of reflectance, the reflectance of the electrochromic display panel 150d is approximately 70%, the reflectance of the flake-type display 150e is approximately 50%, the reflectance of the cholesteric liquid display panel 150c is approximately 30%, and the reflectance of the PDLC-mode liquid crystal display devices 150a and 150b is approximately 10%.

On the other hand, with respect to the transmittances of the display panels 150a to 150e in a transparent state, the transmittance of the electrochromic display panel 150d is slightly low at 10 to 30%, whereas the transmittances of other display panels 150a, 150b, 150c, and 150e are at least 70% and have very little adverse influence on the display of the first display panel.

Additionally, in terms of standby power (power consumed when the first display panel is not displaying or when the power of the display device itself is turned off), the display panels 150c and 150d, which have a memory property, are superior (low power consumption).

The display panels 150a to 150e described above are not capable of realizing display in a dark environment since all of these display panels use ambient light for display. In this regard, a light source 52 may also be provided on an as-needed basis, as is done for a display panel 150f shown in FIG. 10. In other words, the display panel 150f is any one of the display panels 150a to 150e described above that is additionally equipped with the light source 52. The light source 52 illuminates the respective display panel with light when the surrounding is dark. The light source 52 is, for example, an LED light source. In addition, a sensor may also be provided to detect the intensity of ambient light, causing the light source 52 to light up when ambient light falls short of a prescribed intensity.

Needless to say, depending on the purpose of the display device 100A, a self-luminous type display panel, such as an organic EL display panel, may also be used as a second display panel 150A. However, a self-luminous type panel has the shortcomings of low viewability when the intensity of ambient light is strong and high standby power consumption. Nevertheless, a self-luminous type panel is capable of achieving transparency in a non-display state and display quality in a dark environment that are comparable to or greater than those of the cholesteric liquid display panel 150c.

Described above is the display device 100A, in which the light-transmissive cover 200 includes a lens portion provided with edges with a curved surface, so that at least a part of the frame region of the first display panel 100 can be visually concealed. However, the light-transmissive cover 200 is not always necessary. For example, as is done for a display device 100C shown in FIG. 11(a), a light-transmissive cover 200c of the same flat-plate geometry as a first display panel 100 that does not have a lens portion may be used. Additionally, a light-transmissive cover may be omitted altogether as is done in a display device 100D shown in FIG. 11(b).

Next, the structure and functions of a light-transmissive cover that is suited for a display device according to one embodiment of the present invention will be described with reference to FIG. 12. Here, the relative positions of a light-transmissive cover 200 and a first display panel 100 will be explained; as such, the second display panel 150A shown in FIG. 1 will be omitted.

FIG. 12 schematically shows a display device 100A. FIG. 12(a) is a schematic top view of the display device 100A from the observer side. FIG. 12(b) is a schematic cross-sectional view along a 1B-1B′ line in FIG. 12(a).

As shown in FIGS. 12(a) and (b), the display device 100A is equipped with a display panel 100 and a light-transmissive cover 200 that is disposed on the observer side of the display panel 100. The display panel 100 has a display region 120, in which a plurality of pixels are arranged in a matrix of rows and columns, and a frame region 130 that is provided on the outside of the display region 120. The display region 120 is constituted by a peripheral display region 125 that is adjacent to the frame region 130 and a central display region 124, which is a region other than the peripheral display region 125. The light-transmissive cover 200 has a flat-plate portion 250 and a lens portion 210.

The peripheral display region 125 of the display panel 100 refers to a region within the display region 120 over which the lens portion 210 of the light-transmissive cover 200 is disposed on the observer side. The flat-plate portion 250 is disposed over the central display region 124. The lens portion 210 refracts light emitted from the peripheral display region 125 so as to expand an image formed in the peripheral display region 125 into the region constituted by the peripheral display region 125 and the frame region 130.

Here, the direction of rows is referred to as a first direction D1, and the direction of columns as a second direction D2. Found between the display region 120 and the frame region 130 is a first boundary B1 that extends along the first direction D1 and a second boundary B2 that intersects with the first boundary B1 and extends along the second direction D2. Found between the peripheral display region 125 and the central display region 124 are a third boundary B3 that extends along the first direction D1 and a fourth boundary B4 that intersects with a third boundary B3 and extends along the second direction D2.

The peripheral display region 125 includes a first peripheral display area 121, which is enclosed by: a straight line L1 that passes through a point C, where the third boundary B3 and the fourth boundary B4 intersect, and crosses the first boundary B1 at right angle; a straight line L2 that passes through the point C and crosses the second boundary B2 at right angle; the first boundary B1; and the second boundary B2. Additionally, the frame region 130 has a first frame area 131, which is adjoined to the first peripheral display area 121 via the first boundary B1 or the second boundary B2. The first frame area 131 is an area defined by the first boundary B1, the second boundary B2, the straight line L1, the straight line L2, and the outer rim of the display panel 100.

As shown in FIG. 12(b), the lens portion 210 of the light-transmissive cover 200 has a curved surface. In FIG. 12(a), the curving of the surface of the lens portion 210 (the surface on the observer side) is indicated by contour lines. While the intervals of the contour lines are kept constant here for simplicity, this is not necessarily the case.

The lens portion 210 of the light-transmissive cover 200 expands an image formed by the first peripheral display area 121 into the region constituted by the first peripheral display area 121 and the first frame area 131 by refracting light emitted from the first peripheral display area 121. In other words, as shown in FIG. 12(a), the lens portion 210 refracts light emitted from a pixel 10p in the first peripheral display area 121 toward the direction of the first frame area 131 (light emitted toward a direction X1, which extends from the point C to the pixel 10p, for example) toward the direction normal to the first display panel 100 (that is, toward the observer side). Therefore, when an image is observed from a direction perpendicular to the display surface of the display device 100A, the image formed by the first peripheral display area 121 of the display panel 100 is expanded into the region constituted by the first peripheral display area 121 and the first frame area 131, making the first frame area 131 visually inconspicuous as a result.

FIG. 13(a) shows a schematic perspective view of the light-transmissive cover 200.

As shown in FIG. 13(a), the lens portion 210 is provided on the two sides extending along the first direction D1, on the two sides extending along the second direction D2, and in the four corners of the light-transmissive cover 200. The lens portion 210 includes lens bodies 212 and 222 on the two sides extending along the first direction D1, lens bodies 213 and 223 on the two sides extending along the second direction D2, and lens bodies 211, 221, 231, and 241 in the four corners.

Each lens body is disposed over a part of the frame region and the adjacent peripheral display region, and is designed such that light emitted from the pixels within the peripheral display region toward the frame region is refracted toward the direction normal to the first display panel 100 (in other words, toward the observer side). As a result, and in a manner similar to the first peripheral display area 121 explained above, an image formed in the peripheral display region is expanded and displayed in the frame region, allowing the frame region to be visually inconspicuous.

In the display region 120, a plurality of pixels are arranged along the first direction D1 and along the second direction D2 at equal intervals. When the pixels are arranged at an equal interval, it is preferable that the display signals supplied to the pixels along the X1 axis within the first peripheral display area 121 be uniformly compressed in the direction of the X1 axis in comparison to the display signals supplied to the pixels within the central display region 124. In this case, an image formed by light emitted from the pixels found along the X1 axis is expanded to the same size as images formed in the central display region 124. This allows distortion-free displays to be realized in the entire central display region 124 and the peripheral display region 125. Here, compressing the display signals supplied to the plurality of pixels found along the X1 axis is equivalent to compressing the display signals in the first direction D1 and the second direction D2 uniformly at an equal compression ratio.

A light-transmissive cover 200 with all of the four sides having a lens configuration was described above; however, only three sides or two sides may have a lens configuration, and the corners may also have a lens configuration, if needed.

Next, another example of the flat-plate portion 250 will be explained with reference to FIG. 13(b). FIG. 13(b) is a perspective view of a light-transmissive cover 200′. The light-transmissive cover 200′ shown in FIG. 13(b) has a flat-plate portion 250 with a thickness that is smaller than the thickness of a lens portion 210. The surface of the flat-plate portion 250 is found at a position that is lower than the apex of the lens portion 210. The light-transmissive cover 200′ has the advantage of being thinner and more lightweight than the light-transmissive cover 200 shown with reference to FIG. 13(a).

The lens portions 210 of the light-transmissive covers 200 in the present embodiment have a curved surface on the observer side. The curved surface of the lens portions 210 is not limited by these examples, however. A lens portion 210 may have a curved surface on a side opposite to the observer side, or on both the observer side and the side opposite thereto. When both the front and reverse sides of a lens portion are curved, a light incident on the lens portion is refracted twice before exiting. As a result, a light-transmissive cover with a lens portion on both sides has the advantage of being thinner and more lightweight than when only one side is curved. In addition, a lens portion that has a curved surface only on a side opposite to the observer side (in other words, a lens portion with a flat surface on the observer side and a curved surface on the reverse side) is advantageous in that dust, dirt, or the like that adheres to the surface on the observer side is easily wiped off.

### INDUSTRIAL APPLICABILITY

The present invention has broad applications for display devices, particularly for direct view display devices.

### DESCRIPTION OF REFERENCE CHARACTERS

1, 2, 11, 12 substrate
3 liquid crystal layer
6 sealing part
7, 8 polarizing plate
15 backlight device
100 first display panel
100A, 100B display device
120 first display region
121 first peripheral display area
124 central display region
125 peripheral display region
130 frame region
131 first frame area
150A, 150B, 150a to 150f second display panel
200, 200a, 200b, 200c, 200′ light-transmissive cover
210 lens portion
211 lens body
250 flat-plate portion
B1, B2, B3, B4 boundary
D1 first direction
D2 second direction

1. A display device, comprising:
a first display panel that has a first display region; and
a second display panel that is disposed on an observer side of said first display region;
wherein said second display panel becomes transparent when said first display panel is in a display state, and displays prescribed information when said first display panel is in a non-display state.

2. The display device according to claim 1, further comprising a light-transmissive cover disposed on the observer side of said first display panel.

3. The display device according to claim 2,
wherein said light-transmissive cover includes a lens portion having curved edges, and a flat-plate portion, and
wherein said lens portion causes a portion of light emitted from said first display region to be refracted towards a direction normal to said first display panel.

4. The display device according to claim 2, wherein said second display panel is interposed between said first display panel and said light-transmissive cover.

5. The display device according to claim 2, wherein said light-transmissive cover has a recessed section, and at least a part of said second display panel is disposed in said recessed section.

6. The display device according to claim 1, wherein said second display panel is capable of realizing display using ambient light.

7. The display device according to claim 6, wherein said second display panel is a polymer dispersed liquid crystal-mode liquid crystal display panel.

8. The display device according to claim 6, wherein said second display panel is a liquid crystal display panel that has a cholesteric liquid crystal layer.

9. The display device according to claim 6, wherein said second display panel is an electrochromic display panel.

10. The display device according to claim 6, wherein said second display panel has a suspension layer having shape-anisotropic particles.

11. The display device according to claim 6, further comprising a light source that illuminates said second display panel.

12. The display device according to claim 11, further comprising a sensor that detects intensity of ambient light.

13. The display panel according to claim 1, wherein said second display panel is a self-luminous type display panel.

14. The display panel according to claim 13, wherein said self-luminous type display panel is an organic electroluminescent display panel.
